(19) United States
(12) Patent Application Publication
(10) Pub. No.: US 2024/0420073 A1
(43) Pub. Date: Dec. 19, 2024

(54) A TRACKING SYSTEM FOR FACILITATING SECURE DELIVERY OF AN UNDELIVERED ITEM

(71) Applicant: RTRVIT LIMITED, Dorset (GB)

(72) Inventor: Paul Steven DREW, Dorset (GB)

(21) Appl. No.: 18/689,821

(22) PCT Filed: Sep. 12, 2022
(86) PCT No.: PCT/IB2022/058569

§ 371 Date: Mar. 6, 2024

(30) Foreign Application Priority Data
Sep. 13, 2021 (GB) 2113039.8

(51) Int. Cl. G06Q 10/0833; G06K 7/14

(52) U.S. Cl. CPC G06Q 10/0833; G06K 7/1443

(57) ABSTRACT

A tracking and secure retrieval system for an undelivered item. When a letter or package cannot be delivered a reusable token, with unique identifier, is scanned with a hand-held scanner. The reusable token is left at the recipients address in lieu of the item to be delivered. Scanned data includes the unique identifier of the reusable token, the GPS location of the recipients address, time and date stamp data. Information concerning the undelivered item like its tracking history is also stored and made available. This data is processed to generate a unique identification code that is associated with the item at the GPS location. A wireless communication device in the hand-held scanner transmits the unique identification code to a remote server which creates a secure data file. An automatic locker releases the undelivered item when presented with the reusable token which is then cancelled for use on a subsequent occasion.

### FIELD

The invention relates to a tracking system for facilitating secure delivery of an undelivered item such as a letter or parcel.

### BACKGROUND

A problem encountered by many delivery or courier services when a person or recipient is not at home or at an address to where an item is to be delivered, is that the courier has to return the item to a depot or post office so that the item can be stored for subsequent retrieval or collection. In order to ensure the correct person receives the correct item the postman or courier completes a handwritten paper card or postcard with the details of the item to be collected and a suitable time and location from where it can be retrieved.

There is an inevitable cost in supplying these paper cards and a suitable pencil or pen. Additionally a considerable amount of time is spent completing these cards.

These cards are often made of paper and so become wet, damaged and illegible. Therefore, another problem has been, particularly in inclement weather, that information completed by a delivery person, such as recipient's name and address, and time and date of delivery and other details, sometimes becomes smudged or are difficult to discern.

An objective of the invention is to ensure that cards do not become damaged or sodden so that delivery information becomes illegible.

Another problem is that pens leak and have stained a delivery person's clothes as well as other items to be delivered.

Another problem has been, particularly in low light, the delivery person requires a flashlight to complete the information on the paper card.

As courier services become more pervasive, and commercial pressures increase on them, delivery personnel are encouraged to be as productive as possible. One way is for personnel to spend a minimum amount of time when attempting to deliver a letter or package. Therefore there is an increasing tendency to leave undelivered items in so called ‘safe places’. However, there are reports of these items being stolen or lost.

Another objective is therefore to provide a tracking system which is quick and simple to use and which facilitates secure delivery of an undelivered item, such as a letter or parcel.

A further objective is to reduce the amount of paper delivery cards that are sent to landfill.

### PRIOR ART

European patent application EP 1 456 794 (Accenture Global Services Limited) discloses a method and system for the delivery of goods. Remote locker banks are used to store and distribute parcels of previously requested goods to a field operative. The field operative requests, via a computer, one or more goods from a distribution centre, which packages the goods into a parcel and transports the parcel to a locker in a locker bank at a location nearest to the field operative.

The distribution centre and remote locker banks are connected via a central server computer that facilitates communications and operations. The distribution centre also communicates locker information to a field operative, such that the field operative can open the specified locker to retrieve the parcel.

Remote locker banks may be placed near retail stores or service stations, where spill over parcels may be stored when the locker bank is full. The remote locker banks may be placed near retail stores or service stations, where parcels may be stored when the locker bank is full.

United States patent application US 2020/0258334 (Binbox Inc) discloses secure storage platforms and their application in secure temporary property storage. Storage platforms comprise secure locker systems, emergency access and collapsible lockable compartments for secure storage systems for chain of custody management.

A secure storage platform uses a secure protocol to establish a challenge code and a verification code to provide short lived single use access authentication codes to enable secure access and custody management of secured and stored property.

United States patent application US 2006/010077 (Dohrman) discloses a secure pickup and delivery container with a lockable door, a control unit, an access element and an anchoring element. The control unit includes a processing element and a memory that can be programmed with access privilege information such as identity, location, date, time of access, and/or package-specific information.

United States patent application US 2020/334455 (Miller) discloses a system with a camera arranged to capture an image of a delivery item. The system includes a hardware processor operably connected to the camera and that is configured to perform operations that include capturing, using the camera, an image of a delivery item that is undeliverable to an intended recipient or at an intended delivery location, where the image includes an address of the intended recipient. The operations also include embedding, by the hardware processor, processing data with the image of the delivery item to generate an embedded image and notifying a sender of the delivery item that the delivery item is undeliverable using the embedded image.

### SUMMARY OF THE INVENTION

According to a first aspect of the invention there is provided a tracking system for facilitating secure delivery of an undelivered item from a sender to a recipient, comprising: at least one hand-held scanner, which is associated with a delivery person or courier, which includes an imaging means, a memory means, a global positioning system (GPS) device, a processor and a wireless communication device which is operative to transmit signals obtained by the imaging means; a reusable token is adapted to be delivered as security, to a recipients address in lieu of the item, and is redeemable in exchange for the item, the reusable token has a unique identifier which when scanned at a GPS location, by the imaging means, is processed by the processor to generate a unique identification code that is associated with the item at the GPS location; a server is operative to receive the unique identification code, from the wireless communication device in the hand-held scanner, and to associate the unique identification code with an address corresponding to the GPS location; and a database stores the unique identification code and the address, for retrieval when presented with the unique identifier; and a resetting means is operative to place the status of the reusable token into an inactive state suitable for a subsequent usage, in exchange for the item.

An advantage of the invention is that delivery personnel often already carry personal digital assistant (PDA) devices which are used to track secure or secure delivery items and in order to obtain a signature or photographic record of a successful delivery. The system may use a modified version of these PDAs, in the form of a hand-held scanner, in order to scan the reusable token in order to create a record when an item is not delivered.

In some embodiments the reusable token is formed from a synthetic plastics material. An advantage of this is that the reusable token never becomes soggy, or waterlogged. As the reusable token is formed from a synthetic plastics material an adhesive sticker or label may be stuck thereto with an additional or optional note or special message or collection instruction.

Because the reusable tokens are made from a synthetic plastics material, they can be wiped and sanitised and reused many times.

On each occasion of use the reusable token is associated with a specific undelivered package or letter. On collection of the package or letter the reusable token is redeemed and subsequently cancelled. After this the reusable token can be used again, for example on a different day and at a different location.

The cancelling of the reusable token is time stamped and the system ideally registers and records the redemption time by carrying out an update of data relating to the reusable token in the database. This is typically carried out by an authorised person in a collection office or by an automated collection locker.

Optionally the reusable token includes a unique indica such as for example a barcode or a QR code. In addition, the reusable token may include a radio frequency identity (RFID) chip device.

In some embodiments the reusable token may also include braille characters and/or have advertising or other information printed thereon.

Preferably the size of the reusable token is typically the size of a postcard; typically, between 5 cm and 25 cm in length and 5 cm and 20 cm in width.

One option provides the recipient with application specific software (APP) which enables them to scan the reusable token and using a menu to select a suitable alternative delivery time and day. The invention therefore also overcomes problems associated with rearranging a mutually convenient time and day for the courier (when the recipient is planning to be at home) to attempt a re-delivery.

Optionally the recipient may choose to pay a premium fee for this service so that, for example, so-called ‘in-flight’ re-bookings can be made using the recipient's smartphone. So called ‘in-flight’ rebooking is when the recipient may have missed the delivery by a short time and so the courier or delivery person is still on a delivery round and may only be a few hundred metres or so away from the recipient's address. By scanning the reusable token using their smartphone the recipient could be informed of this fact and offered the option of an ‘in-flight’ redelivery.

Software at the server then relays the recipient's request for an urgent redelivery, to the hand-held scanner, for example via a short message service (SMS) text. The courier or delivery person can then either return directly to the address or choose to re-route their planned delivery route (or delivery round) so as to return to the recipient's address and complete the delivery within the newly booked delivery slot. Optionally the server can be configured to update the courier's planned delivery route, by way of an update to a route planner, in order to achieve this with minimum impact on subsequent deliveries.

According to a second aspect of the invention there is provided a hand-held scanner comprising an imaging means, a memory means, a global positioning system (GPS) device, a processor, a battery and a wireless communication device, the imaging means is operative to scan a unique identifier on a reusable token and the processor is operative to generate a unique identification code, to be associated with an undelivered item, at an address corresponding to received GPS location data, at the time and date corresponding to when the reusable token is scanned; the memory means stores the unique identification code; and the wireless communication device is operative to transmit the unique identification code to a remote server.

Preferably the hand-held scanner has a screen on which menu options are displayed. Ideally the screen is a touch screen which enables a user to select options quickly and in poor lighting conditions, for example using a voice command.

Therefore in use and when delivery of an item is unsuccessful, the delivery person or courier operates the hand-held scanner which applies the GPS location data and time and date stamp data, to generate the unique identification code that is associated with the unique identifier on the reusable token. The memory means in the hand-held scanner stores the GPS data and the time and date stamp data that is associated with the unique identifier and so effectively links the unique identifier on the reusable token with the unique identification code that is generated by the processor. This ensures that a data record is captured which may be used to verify that a delivery attempt of an item was made at a specific location and time.

An audible tone (such as a bleep or ping) may be emitted by a loudspeaker as an acknowledgement that the address information and unique identifier have both been scanned. Optionally different tones may be emitted to confirm each item of data has been successfully scanned and the unique identification code has been generated.

After the courier or delivery person has posted the reusable token as a redeemable receipt, the recipient may subsequently use the reusable token to collect the undelivered item or to re-book another delivery day and time.

Further specificity may be incorporated by enabling the courier or delivery person to include information relating to the particular undelivered item. This may be important for example when an attempt is made to deliver more than one item at one address, and none can be delivered. In this instance the delivery person or courier may also scan address information that appears on the item to be delivered. The address information on the undelivered item is then also used to generate the unique identification code and thereby the reusable token is also associated with a specific letter or package.

Address information may be derived from a barcode or a QR code on an address label or on a prepaid postage label or from a suitably modified postage stamp, (for example a postage stamp with a QR code formed thereon), attached to the undelivered item. This address information is obtained automatically by the imaging means on the hand-held scanner and may be used to provide address image data which can be used, with the existing time and date stamp data and the GPS location data, to generate the unique identification code.

Where an item to be delivered does not include a barcode or QR code, the imaging means may optionally be configured to transmit a digitised image of a typed or handwritten address, to an optical character recognition (OCR) device, which converts imaged characters from the address to provide address image data. The processor is then selectively configured to use the address image data to generate the unique identification code that is associated with the item at the GPS location.

In some embodiments, the tracking system associates an identity of the delivery vehicle, driven by the courier or delivery person, with a particular hand-held scanner for safety and security purposes as well as being able to update ‘in-flight’ information to a courier or delivery person and in order to vary a delivery or collection route.

In this preferred embodiment the hand-held scanner is modified in order to provide the delivery person or courier with a choice of options, which are displayed on the screen on the hand-held scanner, so that for example the delivery person or courier is able to quickly select a suitable scanning option using a touch screen menu or a menu that responds to voice commands.

The address to where a delivery is being attempted is determined automatically by the global positioning system (GPS) device in the hand-held scanner at the instant of scanning. This is the location at which the courier or delivery person is present, at the instant of scanning the reusable token, and shortly after a delivery attempt has been made. Should a situation arise when a recipient is able to accept a delivery, and the delivery person or courier has already scanned a reusable token in readiness to post it through the recipient's letterbox, the reusable token may be cancelled, and the item delivered at the address.

At a collection locations, such as post office or authorised store, a system scanner may be configured to check whether a reusable token is active or live, prior to collection. Recipient information may be displayed on the display to ensure the token is allocated to a particular undelivered item. Once the status of the reusable token has been verified, and the item has been redeemed, the reusable token is cancelled and returned for reuse.

Optionally the server may provide a recommended delivery route to a courier or delivery person which is based the amount of undelivered items recorded and this route may be updated in real time by the server.

Optionally the hand-held scanner may have a means for receiving contactless payment for enabling a recipient to make a payment for example for express delivery of a letter or package or an ‘in-flight’ rebooking for which a courier company may charge a premium fee.

All data that is stored in the memory means is provided for immediate transmission to the server via the wireless communication device. However, if this is not possible, for example if the hand-held device is in a building or at a location with poor signal reception, a request from a controller is made when a suitable wireless signal is detected, and re-transmission is attempted. This aspect of the real time operability of the hand-held device is important, for example for enabling the courier to be able to receive ‘in-flight’ delivery route variations and re-bookings from recipients using their smartphones or a personal computer (PC).

Upon receipt at a server, all data records are stored on the database. The data records which are accessible from the database include: time data and date stamp data and unique identifier data (recorded indelibly on the reusable token) and the address data corresponding to the GPS location, as well as the attempted delivery time of the item.

When the recipient redeems the reusable token to collect their undelivered item, additional data relating to collection time and date and identity data of the recipient which may include verification of their identity from a passport, driving licence, identity (ID) card or a biometric indicator such as a fingerprint, may be requested.

As mentioned earlier, the tracking system includes an option for a user or subscriber to download application specific software (APP) to modify a mobile communication device, such as smartphone, so as to enable a recipient to access an online booking system. The online booking system optionally provides a user with choices of selecting an alternative delivery time and date; the option to return the undelivered item to, or an option to collect the undelivered item from, a specified location, such as a secure locker. However, other features may be provided by online booking systems. These features may be specified by a sender or a recipient or a delivery company or a database manager. Some of these features are described below as definable criteria.

By accessing the online booking system, the recipient may request the server to allot a secure locker and relay information about this to the courier or delivery person so that an undelivered item can be deposited in the locker for subsequent collection. The server then may transmit an authorisation code to the recipient to enable them to access the secure locker with the reusable token. A fine (or refundable deposit) may be imposed if the reusable token is not redeemed and only the code is used to collect the item, at which time the reusable token is automatically cancelled.

Automatic access to the locker is however preferably achieved by the recipient using a token reader which when presented with the reusable token, actuates a release catch or lock mechanism allowing the recipient to access the contents of the locker. A receptacle (not shown) is provided into which the recipient places the now unusable token or card as it has been redeemed.

Optionally a security camera may photograph the recipient for audit purposes and to provide evidence of collection of the item. In addition it is understood that the database is capable of storing all related data, including: time stamp data, date stamp data, unique identification code data, unique identifier data corresponding to the reusable token and address data corresponding to the GPS location, time and location of collection of the item and identity data of the recipient for purposes of providing an audit trail.

In some embodiments the application specific software may configure an authorised user's smartphone which enables that person to collect the item for example on behalf of the recipient. The user may then display, or transmit, a release signal to an automatic release means on the secure locker and this option may be helpful where the recipient is old or infirm and unable to collect the item in person and so may appoint the authorised person as a proxy to collect the undelivered letter or package on their behalf.

Automatically accessible lockers or banks of lockers may be provided in supermarkets or shopping malls to enable collection outside normal working hours of a post office. Collection from such locations may attract a surcharge or be available only by premium account users. Lockers may be fitted with keypads for entering a personal identity number or release code. In another system a fingerprint reader, or voice or facial recognition (or other biometric) system may be provided to identity the recipient, or a person authorised by the recipient, to collect their item. Likewise the system may be configurable to anonymise certain types of data or meta data.

The system includes a supervisor with the ability to negate or cancel the unique identification code when a lost or stolen card is reported so as to prevent a thief from illegally using the card to retrieve the undelivered item.

Preferably the reusable token is redeemable only for a predetermined validity term which may be determined by a service provider, manager or the delivery person. The validity term may be a week, a fortnight or a month, for example. At the end of the validity term the undelivered item would normally be returned to the sender, at which time the unredeemed reusable token is cancelled or voided so that it is no longer redeemable.

Cancellation of the reusable token takes place automatically when the undelivered item is returned to a sender and the system is updated by the person who is responsible at a post office or sorting office and who uses a system scanner when dispatching uncollected items or packages to be sent for return to the sender. This may also be performed automatically at a locker with a suitable means for receding the reusable token.

It is appreciated that the person who uses the system scanner effectively cancels the reusable token and does not actually require the reusable token, because it is the database which is updated with the status of the reusable the reusable token.

Preferred embodiments of the invention will now be described with reference to the Figures in which:

### BRIEF DESCRIPTION OF THE FIGURES

FIG. 1 shows a diagrammatical overall view of an unsuccessful attempt to deliver a package or letter by a delivery person or courier at an address;

FIG. 2A is a simplified overview of a system showing key features;

FIG. 2B shows steps in the generation of a unique identification code using a unique identifier on a reusable token and data corresponding to the location and time of an unsuccessful delivery attempt corresponding to the system;

FIG. 3 is an overall diagrammatic view of a hand-held scanner which is optionally also used to photograph an address on an undelivered letter or package prior to return of an undelivered item to a post office or secure storage for subsequent collection;

FIG. 4 is a diagrammatic view of a recipient collecting the undelivered package from a post office or from an automatic collection locker;

FIG. 5 is an example of a system in which a shared database is accessed by different postal service providers or courier companies;

FIG. 6 is an example of a system in which separate proprietary databases are accessed by different postal service providers or courier companies;

FIGS. 7 to 11 show examples of a menu presented to a courier or delivery personnel from their hand-held scanner;

FIG. 12 is an example of the reusable token with a QR code for scanning;

FIGS. 13 to 20 show examples of menus presented on a recipient's smartphone which are displayed when the recipient scans the reusable token.

### DETAILED DESCRIPTION OF PREFERRED EMBODIMENTS

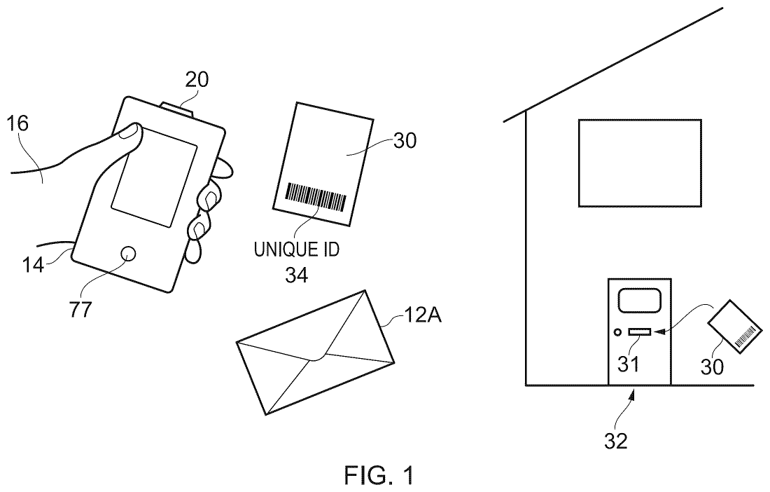

Referring to the Figures, and in particular FIG. 1, there is shown a diagrammatical view of a courier or delivery person 16 attempting to deliver a registered letter 12A, (which requires a signature from a recipient or photographic evidence confirming deliver) to the recipient's premises 32, using a hand-held scanner 14.

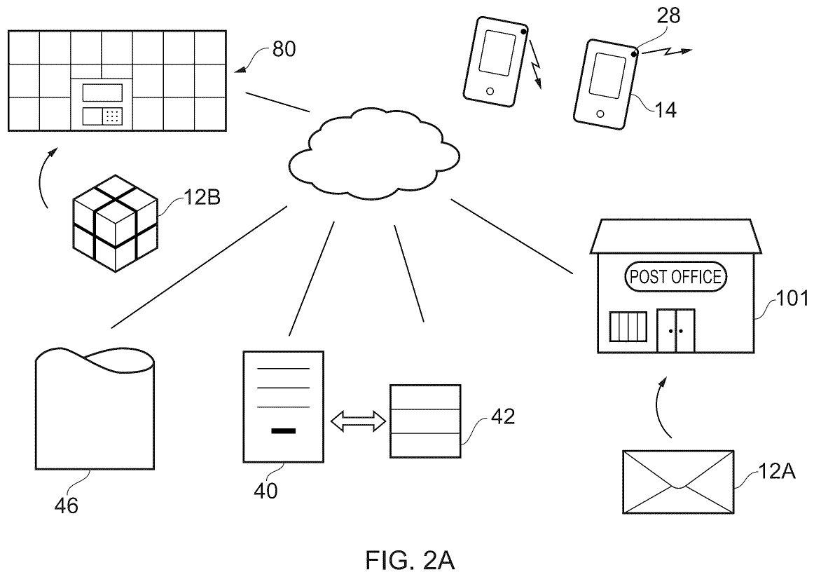

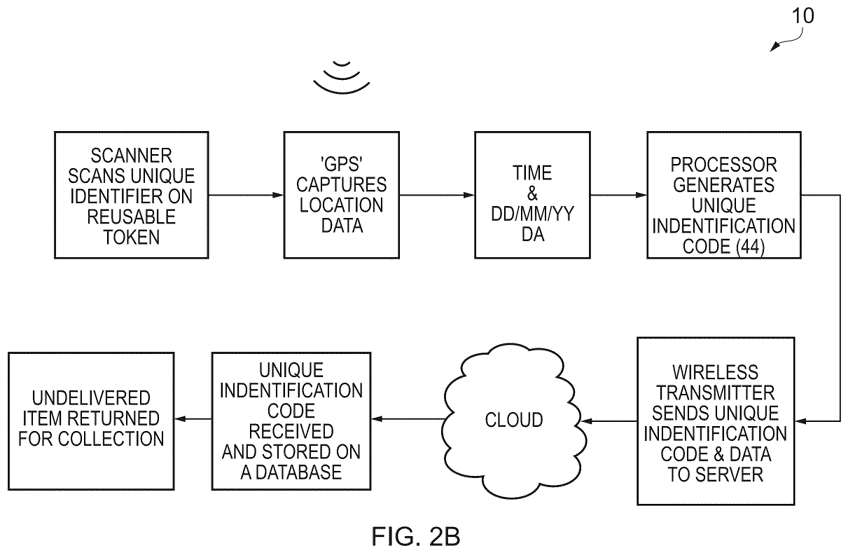

The system 10 (shown in FIG. 2B) comprises: a hand-held scanner 14 which is operated by pressing button 77. The hand-held scanner is carried by a delivery person 16. When operated by the delivery person 16 the hand-held scanner 14 associates the identity of the delivery person or courier (as well as the time and date of a specific delivery round or shift) with the undelivered item 12A at a GPS location corresponding to an address which in turn may be linked to a postcode (zip code).

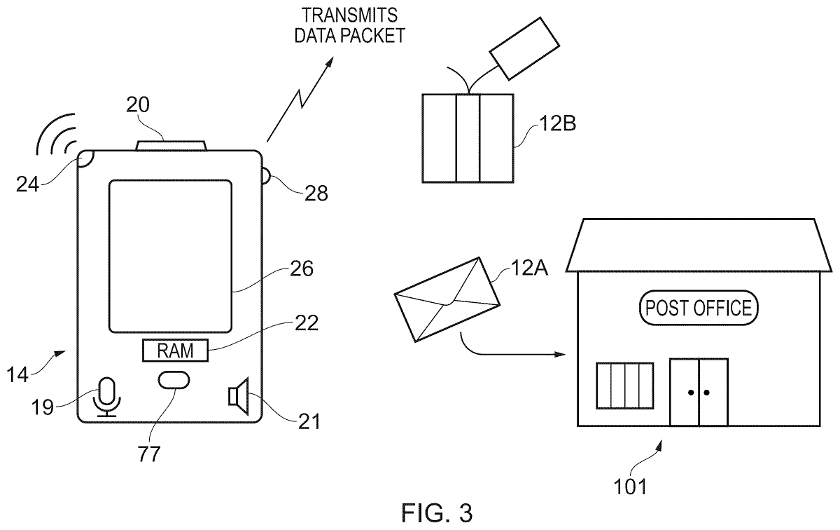

The hand-held scanner 14 includes an imaging means 20, a memory means 22 (as shown in FIG. 3), a global positioning location (GPS) device 24, a display 26 and a wireless communication device 28 which may be wireless device operating in accordance with a Bluetooth® wireless protocol or a cellular network wireless protocol; or both short range and long range wireless systems.

In some embodiments the hand-held scanner may include a contactless payment means which is operative to receive payment from a credit or debit card or a from a suitably configured smartphone.

Optionally the hand-held scanner 14 has a microphone 19 to enable a delivery person to make an audio note and a loudspeaker 21 which enables audio messages or instructions to be replayed. The wireless communication device 28 is operative to transmit signals obtained by the imaging means 20. A reusable token 30 is adapted to be delivered as security, at a recipients address 32 in lieu of the item to be delivered which at this time is referred to as the undelivered item as soon as the reusable token is posted through the recipient letterbox 31 or deposited in their mailbox. The reusable token 30 is redeemable in exchange for the undelivered item as described below.

Referring again to FIG. 1, the reusable token 30 has a unique identifier 34, such as a barcode or QR code, which when scanned at a GPS location corresponding to the recipient's address, by the imaging means 20, is processed by a processor (not shown) in the hand-held scanner 14 to generate a unique identification code 44 that is associated with the undelivered item and the GPS location corresponding to the recipient's address.

Records data is transmitted as a packet to a remote server with a controller 42 which is operative to receive the unique identification code, from the wireless communication device 28 in the hand-held scanner 14, and to associate the unique identification code with an address corresponding to the GPS location. The database 46 stores the unique identification code and the address for retrieval when presented with the unique identifier and a resetting means, which may be automatically operated by a locker for example, or manually operated by an operator (not shown) in a post office, is operative to place the status of the reusable token 30 into an inactive state suitable for a subsequent usage, in exchange for the item 12A or 12B.

In some embodiments the reusable token 30 is formed from a synthetic plastics or a naturally occurring material, such as for example bamboo, which may be recycled. An advantage of this is that the reusable token 30 does not become soggy, or waterlogged, nor is there any risk of any written information becoming illegible. The reusable token 30 includes instructions, for example requesting the recipient to return it to a post office 101 or a secure bank of lockers, in order to redeem the reusable token 30 in exchange for their undelivered letter 12A or parcel 12B.

The reusable token 30 includes a unique indica such as for example a barcode or a QR code. In addition, or in an alternative embodiment, the reusable token may be fitted with a radio frequency identity (RFID) chip device (not shown).

In some embodiments the reusable token may also include braille characters for assisting blind or partially sighted recipients to identify the reusable token 30 and to indicate its significance and indicate that a sighted person's assistance may be required.

The size of the reusable token 30 is typically the size of a postcard; typically, the reusable token is between 5 cm and 25 cm in length and 5 cm and 20 cm in width. Because the cards are small and flat, they do not crease and so occupy very little space in wall mounted letterboxes which are often found in student accommodation.

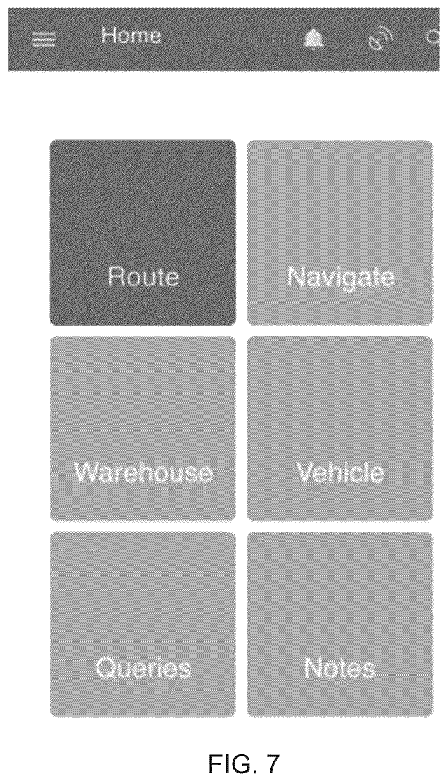

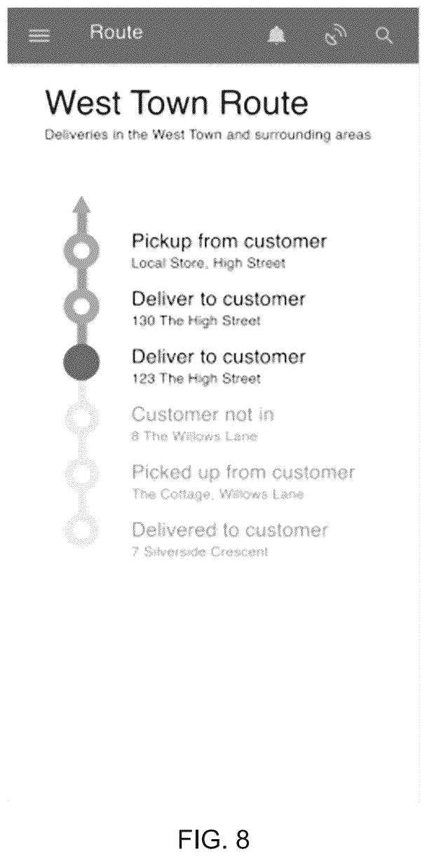

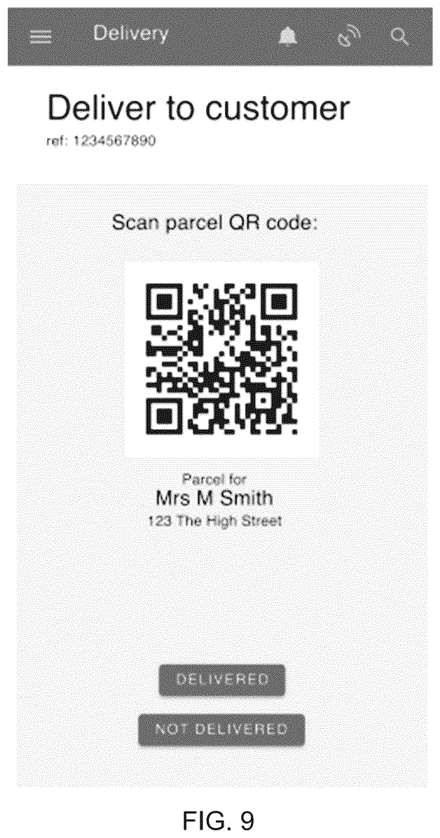

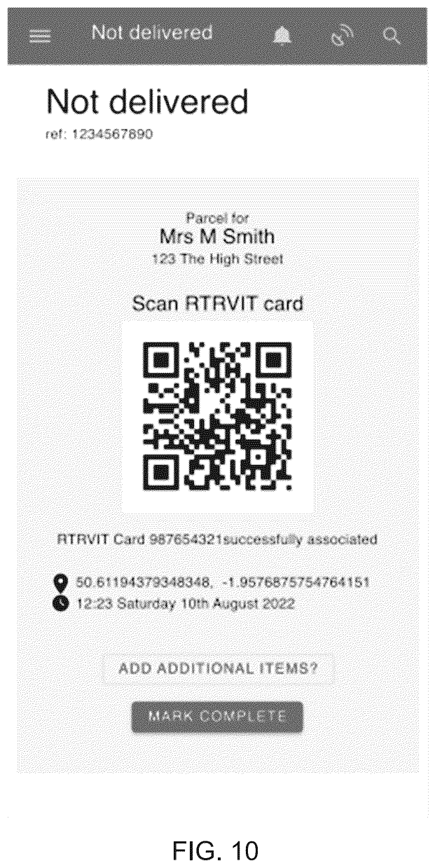

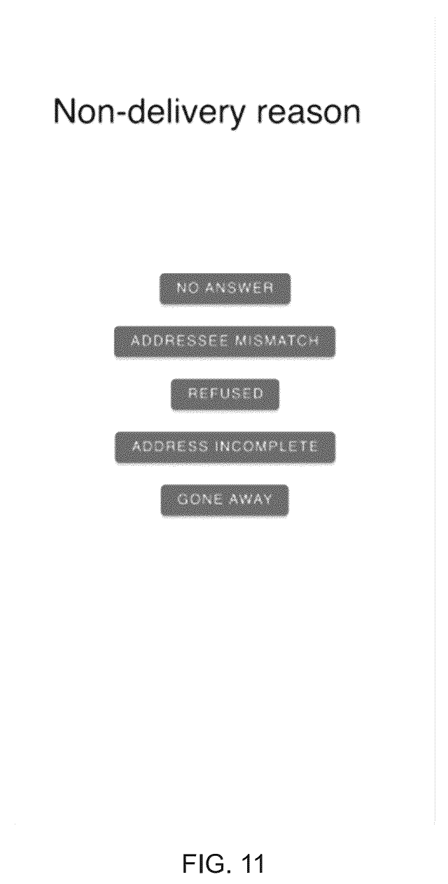

Referring briefly to FIGS. 7 to 11, when delivery attempt of the item 12A or 12B is unsuccessful, the delivery person or courier uses their hand-held scanner 14 to apply a time and date stamp (FIG. 2B), that is associated with the unique identification code and the GPS location of the address. The display 26 on the hand-held scanner 14 offers the delivery person or courier a number of options. After options, displayed in FIGS. 9, 10 and 11, have been accepted and selected, the delivery person or courier then posts the reusable token 30 through a letterbox 31, or in a specific mailbox of a communal letterbox, for example as found at shared occupancy premises, or leaves the reusable token in a mailbox (not shown) at the recipient's premises.

At this time a memory means 22 in the hand-held scanner 14 stores time and date stamp data that is associated with the unique identification code and data associated with the unique identification code on the reusable token and the GPS location at the instant of scanning. This ensures that a data record is captured which links the undelivered letter 12A or package 12B to the recipient's address and the identity of the hand-held scanner 14 (and thereby the identity of the delivery person 16) and an intended delivery time and date. The physical address to where delivery is intended is determined automatically by the global positioning system (GPS).

All data derived from the imaging means 20 and from the GPS device 24 (FIG. 3) and time and date stamp data, as well as other data records, are stored in the memory means 22 for immediate or subsequent transmission, as data packets, to the server 40 via the wireless communication device 28 when a suitable signal strength is detected. This process is illustrated in a functional steps in FIG. 2B.

Upon receipt at the server 40 the data record is stored on a database 46. The data record that is accessible from the database 46 includes: time data and date stamp data, the unique identifier (recorded indelibly on the reusable token 30), the address data corresponding to the GPS location, the attempted delivery time and day, and the unique identification code generated by the processor.

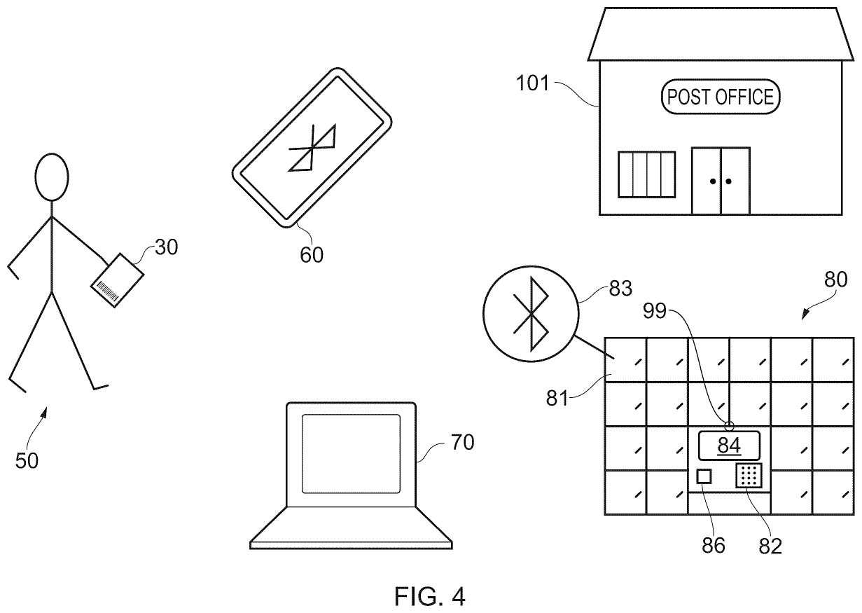

Referring to FIG. 4 when the recipient arrives to collect the undelivered item 12A or 12B with the reusable token 30, additional data relating to collection time and date and identity data of the recipient which may include verification of their identity from a passport, driving license or identity (ID) card (not shown).

The tracking system includes an option for a user or subscriber 50, who may be the sender or the recipient, to download application specific software (APP) to modify a mobile communication device, such as a smartphone 60 so as to enable a recipient to access an online booking system. The online booking system optionally provides a user, for example via their smartphone 60 or personal computer 70, which communicates via the Internet to server 40, with choices of selecting an alternative delivery time and date or collecting from a specified location or an automated locker or a secure locker 81, in a bank of lockers 80. Additionally an option to return the undelivered item may be provided. Other owner specified criteria, as mentioned below, include an option for a sender to receive a notification of delivery or a delivery attempt as well as acknowledgement that a reusable token 30 has been scanned and the sent item or package has been successfully redeemed.

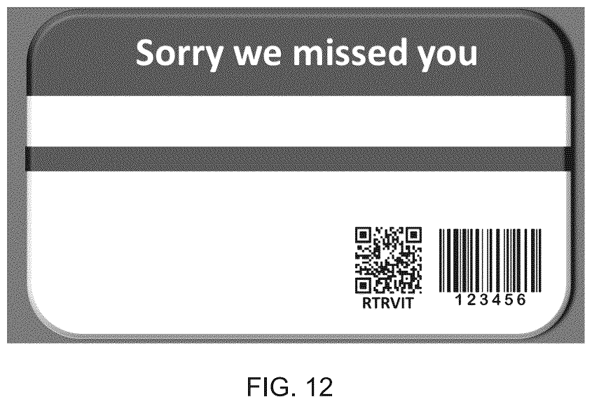

FIG. 12 shows an example of the reusable token 30 with a QR code for scanning which is collected by the recipient when they return home.

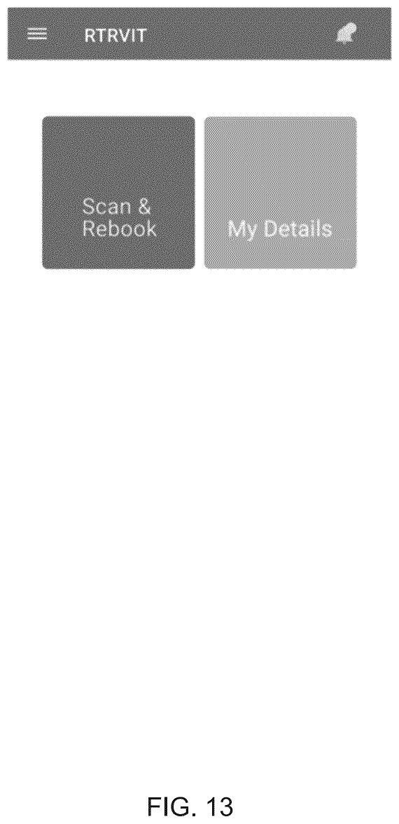

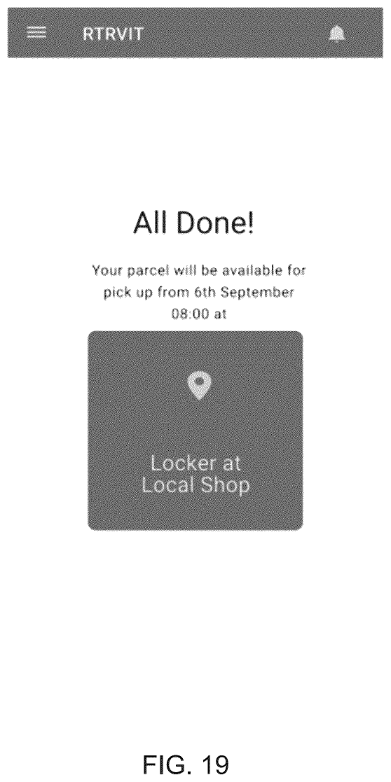

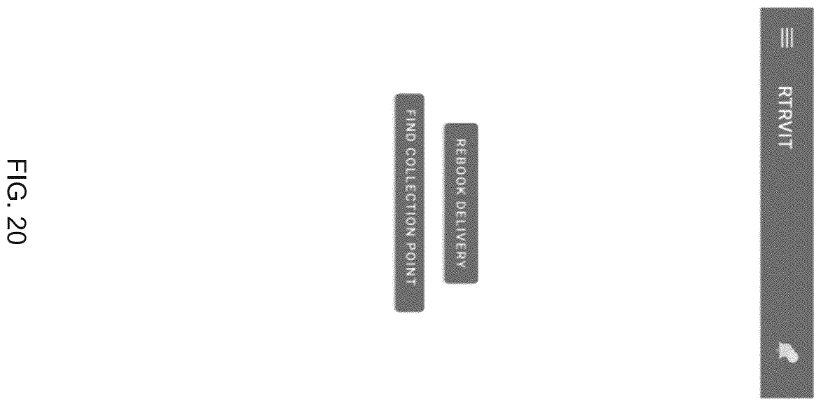

Referring to FIGS. 13 to 20, examples of menus are shown which are presented on the recipient's smartphone (not shown) after the recipient scans the QR code on the reusable token 30 with their smartphone. By accessing an automated booking system, which is supervised by the server 40, the recipient may instruct the courier or delivery person to place the item in a secure locker 81. The server 40 then transmits a suitable authorisation code and recipient identity to that secure locker 81.

Access to the secure locker is achieved by the recipient using their smartphone 60 and/or upon presentation of the reusable token 30. A resetting means at the secure locker (or at another retrieval location, such as a nominated store or post office), when presented with the unique identifier on the reusable token, is operative to place the status of the reusable token into an inactive or cancelled state suitable for a subsequent use in exchange for the item. The reusable token is then able to be reused in connection with a different item by a different delivery person to a different address on another occasion. Cancellation of the reusable token is therefore transacted in exchange for the item.

In some embodiments the application specific software may configure a user's mobile communication device 60, (smartphone) to display or transmit a release signal, for example via a Bluetooth® wireless protocol, to an automatic release means 83 on the secure locker 81.

In some embodiments the receptable is provided in the secure locker for the reusable token. In some embodiments a security camera 99 is provided in a bank of secure lockers 80.

Automatically accessible lockers 80 or banks of lockers may be provided in supermarkets or shopping malls to enable collection outside normal working hours at a post office 101. Collection from such locations may attract a surcharge or a premium fee may be payable when this option is selected. Such payments may be made using an online account.

A secure bank of lockers 80 may be fitted with a keypad 82 for entering a personal identity number or release code as well as a display 84. In addition, a voice, biometric or facial recognition system 86 may be provided at the bank of lockers 80 to identity the recipient and/or the unique identity of the reusable token 30.

It will be appreciated that a number of operational parameters, or operating criteria, may be defined to suit specific situations. These operating criteria may be further sub-divided into sender defined criteria, courier defined criteria, owner defined criteria and delivery person defined criteria.

Operational parameters, or operating criteria may be specified at different operational levels within the system. For example, at different customer, user and supervisor levels. Some of these are described below and with reference to the Figures and each of these different criteria may be configurable at various times and stages of a delivery process.

### Sender Defined Criteria

A sender may specify that a recipient is required to provide further input data, such as a code or a date of birth for example. Other sender defined criteria may include an option to receive a message that a delivery attempt was made: an option to receive a message that a reusable token was left as security to be redeemed in exchange for the item or package that was sent; an option to receive a message confirming when an attempt to scan the reusable token 30 is made by the recipient; or an option to receive a message when the item or package has been successfully collected. When the unique identifier (QR code and/or a barcode) on the reusable token 30 is scanned by a smartphone a notification is generated on the display 84 and when the notification is accepted, the smartphone automatically connects to a remote database. Data tags enable customer specific data and/or product specific data and/or retailer specific data to be shared and relevant information (such as hyper inks) or promotional information to be sent to a user's smartphone or as an email to a user's email address.

### Courier or Delivery Person Defined Criteria

A delivery person or courier may configure their hand-held scanner to present different menus. FIGS. 7 to 11 show examples of such menus presented to a courier or delivery person from their hand-held scanner.

In addition other courier specified criteria enable a courier, for example to appoint a secondary courier (or partner company) to deliver a package on their behalf. This may be useful in situations of so-called ‘last mile’ delivery. This option may be of particular convenience when a courier attempts to deliver items to a remote vicinity and several items remain undelivered. In such circumstances it may be more cost effective for the courier to negotiate with a third party company to redeliver items, rather than travel to the remote vicinity on another occasion with only a few items.

Additionally the hand-held scanner may be configured to receive updates in so-called ‘in-flight’ re-bookings so that a new route for the courier may be displayed and updated. Such ‘in-flight’ variations enable a recipient to redirect a package for delivery or collection to a selected location and a courier or delivery person is able to configure the system to ignore such requests or accept them.

The third party may be a postal service for example and may levy a transaction fee to the first courier for the final delivery. The fact that a system collates and records all aspects of a delivery chain, facilitates such transactions to be settled for example every day or every week or any other specified time.

### Recipient Defined Criteria.

A recipient may configure recipient data so that a nominated trusted third-party may be authorised to collect a package on behalf of the recipient by relaying a code or QR code or even an image of the code from the reusable token to the trusted third-party, for example via short messaging service, email or other electronic means.

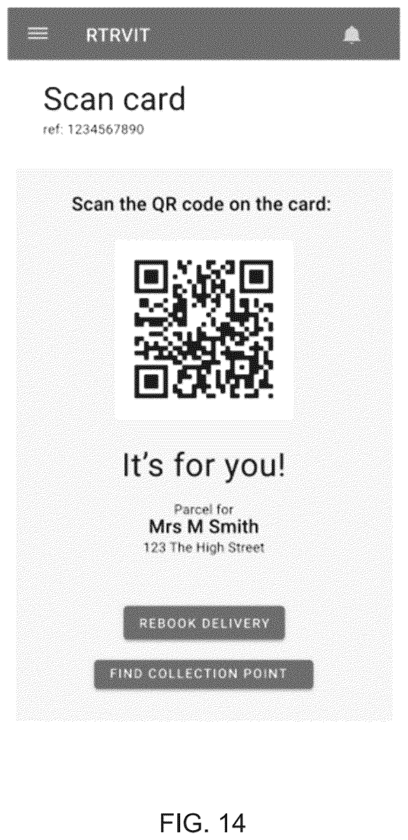

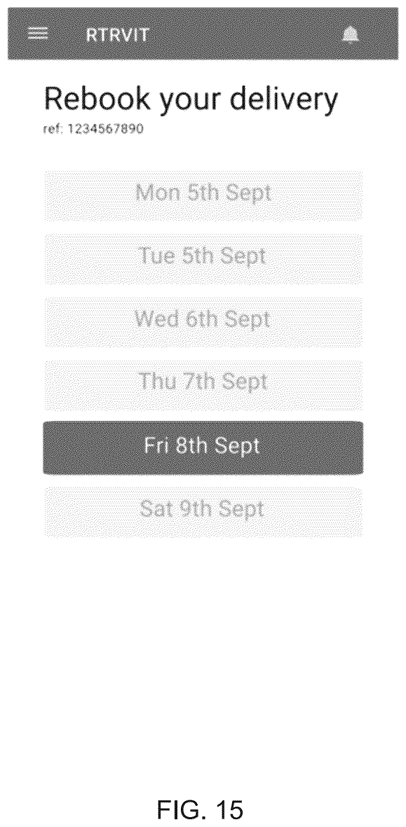

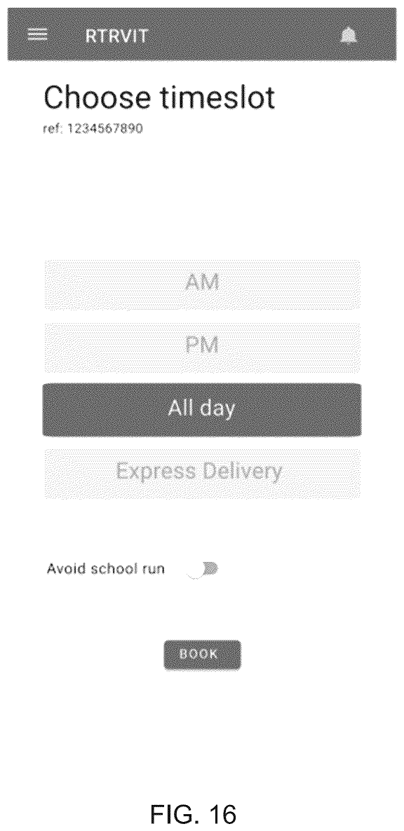

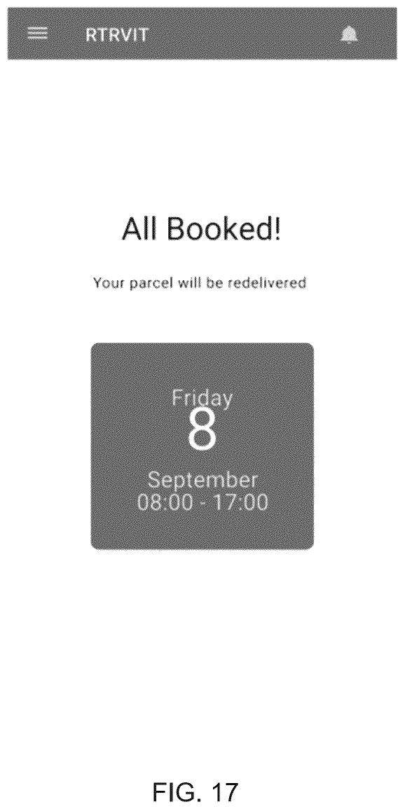

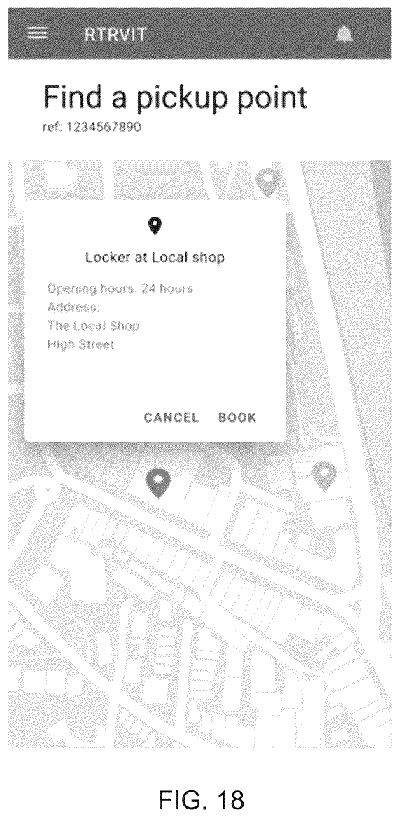

FIG. 13 is a master menu and FIG. 14 shows a replica of the QR code after the reusable token 30 has been scanned. FIGS. 15 and 16 offer the recipient choices of alternative days and times. FIG. 17 confirms a rebooking has been made and FIG. 18 displays a map showing the location of a secure automated collection locker 81.

When the reusable token 30 has been scanned other options may be presented to the recipient on their smartphone. Such options include pop-up adverts, adverting links with hyperlinks to website based services and providers of related goods and services, for example based on user profile historical data.

Other criteria may be specified by a recipient for example so-called ‘in-flight’ re-bookings to enable a recipient to select a time and date for the courier to make a redelivery. Such ‘in-flight’ variations also enable a recipient to redirect a package for delivery or collection to a selected location. Suitable software at the server may have information including the size and weight of the undelivered item. This enables automatic allocation of a suitably sized locker to be allotted for receiving and storing the item, of specified dimensions, for a predefined period.

FIGS. 13 to 20 show examples of a series of menus presented to a recipient for display on their smartphone 60. These menus (FIGS. 13, 14, 15 and 16) are presented when the recipient's smartphone 60 is operating in accordance with application specific software and after the QR code on the reusable token 30 has been scanned.

Another recipient defined criterion enable the recipient to relay details or information from the reusable token 30 to a friend or relative and authorize the friend or relative to collect the package from a post office or secure collection facility on behalf of the recipient. An advantage of this is that it enables someone who is unwell or infirm to have the item collected by nominating a proxy who may be a friend or relative. As the reusable token 30 may not be redeemed it is cancelled and a deposit charged, which may be refundable, for example when the reusable token 30 is returned to the delivery person or courier or a post office or a suitable automated locker.

### Owner Defined Criteria

An owner may specify that certain aspects of data or meta data, for example relating to a sender, a recipient, a user or a specific transaction or part of a delivery process, is restricted in accordance with local data protection legislation which in the UK for example is referred to general data protection regulations (GDPR).

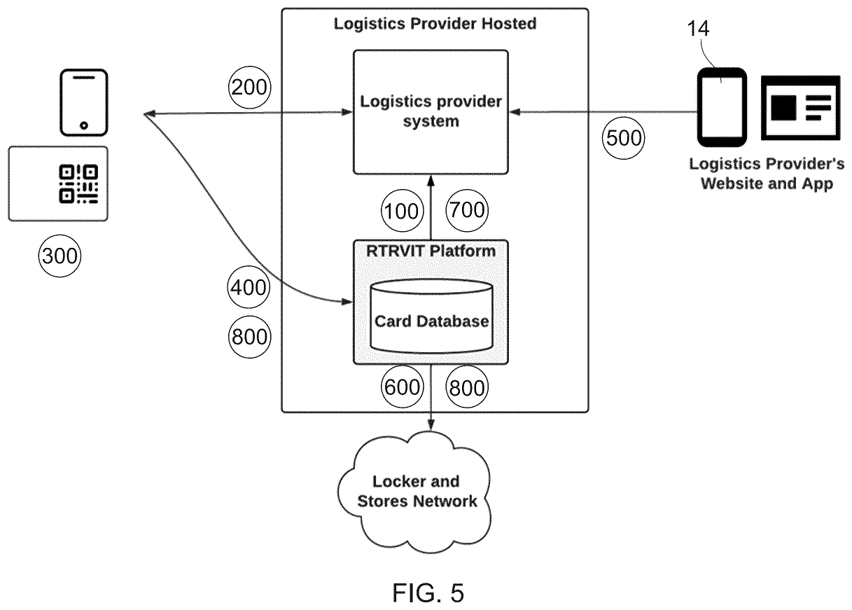

FIG. 5 is an example of a system in which a shared database is accessed by different postal service providers or courier companies. As part of this restriction such data may be encrypted or provided with different user access rights. Optionally the owner may permit that certain data or meta data are available for specific third-party or specified third-party uses which may be governed for example by license agreements or service contracts between courier companies or postal services.

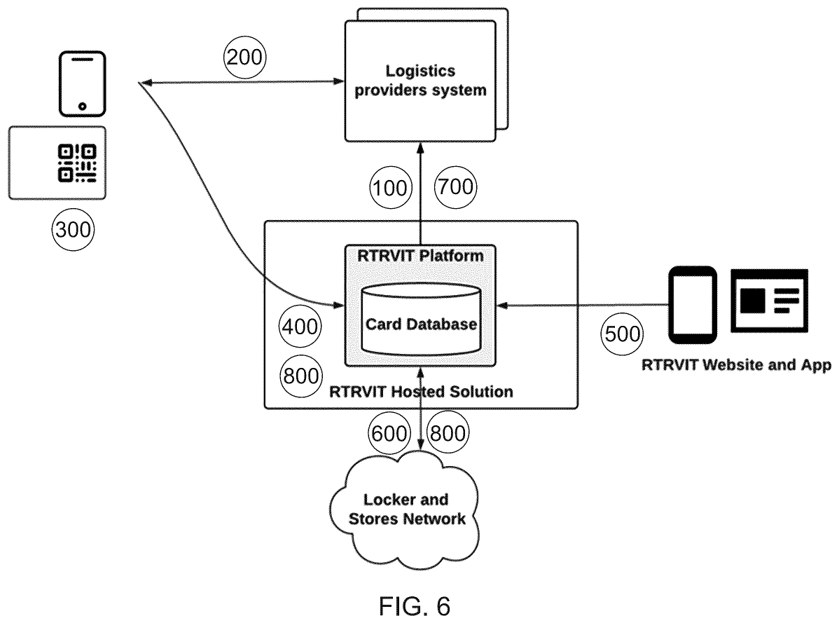

FIG. 6 is an example of a system in which separate proprietary databases are accessed by different postal service providers or courier companies.

The system can be deployed in several modes, two of which are described below.

In one mode the system may be deployed as a central platform, which operates and is managed by a bespoke server to which a delivery company, post office or logistics provider may subscribe. The bespoke server provides access via a single common website and enables recipients to re-book a delivery. An example of this configuration is shown in FIG. 5.

Alternatively, as shown in FIG. 6, the system may be deployed as a platform that can be custom built and deployed within each separate logistics provider (LP) for their dedicated usage. An advantage of this is that such custom built system may be readily integrated with existing system to support re-delivery or collection of the undelivered item 12A or 12B.

Reference is made to each of FIGS. 5 and 6 for the following High Level Flow steps:

100 A logistics provider (LP), such as a post office 99 or courier company, is able to order, receive and make provision for the reusable tokens using a version of the present invention, for example as shown in FIG. 2B. In such a system all communications with server are typically made using an application programming interface (not shown).

200 In such a configuration, the system operated and used by the logistics provider (LP) would then function as normal to support delivery and tracking of customers packages.

300 At point of delivery, if an item or package cannot be delivered, a courier or delivery operative associates the reusable token 30 with the package, using their hand-held scanner 14, as described above, and posts the reusable token 30 through the recipient's letterbox.

400 Data is transmitted to the server and the database is updated, as shown in FIG. 2B. Data can be communicated directly to the server from the hand-held scanner 14 or via a separate database operated by the logistics provider which receives data from each hand-held scanner 14.

500 A recipient can use the information on the reusable token 30 to visit a website or download suitable software, for example in the form of a ‘mobile app’ to rebook the delivery or arrange a collection from a secure locker or other designated location. If the recipient is a registered user, then the recipient will be alerted to the fact that an undelivered item 12A or 12B has been delivered to their address and delivery needs to be rearranged. A bespoke website or ‘mobile app’ allows the recipient to select a redelivery or a pickup option, as illustrated in FIGS. 13 to 19.

600 If the recipient chooses to collect the undelivered item 12A or 12B from a store or a secure locker, then this option is communicated to the store or locker provider.

700 If the recipient selects re-delivery, this option is communicated via the server to the logistics provider (LP). Alternatively, if the recipient has selected to have the letter or package redelivered, the server provides this information to the logistics provider (LP) to enable them to allocate the item for a subsequent delivery, an ‘in-flight’ rebooking or delivers the item to a receiver defined location.

800 Upon successful collection or redelivery, the store or locker network or the logistics provider communicates data pertaining to this to the server and a database relating to status of the reusable token is updated.

### Manager Defined Criteria

Manager defined criteria enable, for example a manager of a post office or a courier company, may be authorised to specify a redemption term for a predetermined validity term. This validity term during which the reusable token is redeemable, may be a week, a fortnight or a month, for example. At the end of the validity term the undelivered item 12A or 12B would be flagged for return to the sender, at which time the unredeemed reusable token is cancelled or voided so that it is no longer redeemable.

A surcharge or a premium payment option for a local pre-arranged redelivery time, which may be ‘out of hours’, may also be offered to customers.

The invention has been described by way of example only and it will be appreciated that variation may be made to the embodiments described without departing from the scope of the protection as defined by the claims.

For example, a biometric identification data, may be used by a recipient to retrieve their item and the biometric data may include encrypted fingerprint data or other identification information specific to the recipient. Such data may be obtained by a bespoke device or provided from a recipient's smartphone.

1. A tracking system for facilitating secure delivery of an undelivered item from a sender to a recipient, comprises: at least one hand-held scanner, which is associated with a delivery person or courier, which includes an imaging means, a memory means, a global positioning system (GPS) device, a processor and a wireless communication device which is operative to transmit signals obtained by the imaging means;
a reusable token is adapted to be delivered as security, to a recipients address in lieu of the item, and is redeemable in exchange for the item, the reusable token has a unique identifier which when scanned at a GPS location, by the imaging means, is processed by the processor to generate a unique identification code that is associated with the item at the GPS location;
a server is operative to receive the unique identification code, from the wireless communication device in the hand-held scanner, and to associate the unique identification code with an address corresponding to the GPS location; and
a database stores the unique identification code and the address, for retrieval when presented with the unique identifier; and a resetting means is operative to place the status of the reusable token into an inactive state suitable for a subsequent usage, in exchange for the item.

2. The tracking system according to claim 1, wherein the scanner is operative to obtain address information from the undelivered item to generate the unique identification code and thereby associate the reusable token with a specific letter or package.

3. The tracking system according to claim 2 wherein the address information is derived from a digitised image of a typed or handwritten address supplied by an optical character recognition (OCR) device, which converts imaged characters from the address to provide address image data.

4. The tracking system according to claim 1 wherein the scanner is operative to derive address information from a barcode on an address label (or on payment label) or from a QR code on an address label (or on payment label).

5. The tracking system according to claim 1 wherein the scanner is operative to derive address information from a prepaid postage label or from a stamp attached to the undelivered item.

6. The tracking system according to claim 1 wherein the reusable token is formed from a synthetic plastics material.

7. The tracking system according to claim 1 wherein the unique identifier on the reusable token includes a barcode.

8. The tracking system according to claim 1 wherein the unique identifier on the reusable token includes a QR code.

9. (canceled)

10. The tracking system according to claim 1 wherein the reusable token includes braille characters.

11. (canceled)

12. The tracking system according to claim 1 wherein the hand-held scanner applies a time and date stamp to generate the unique identification code.

13. The tracking system according to claim 12 wherein the time and date stamp and the unique identification code are stored in the memory means in the hand-held scanner.

14. The tracking system according to claim 13 wherein data, including time data and date stamp date, unique identification code data and address data corresponding to the GPS location, is temporarily stored in the memory means and is transmitted to the server when the wireless communication device receives a request from a controller which indicates when a suitable wireless signal is detected.

15. The tracking system according to claim 1 wherein a database stores data, including time stamp data, date stamp data, unique identification code data, unique identifier data corresponding to the reusable token and address data corresponding to the GPS location, time and location of collection of the item and identity data of the recipient for purposes of providing an audit trail.

16. The tracking system according to claim 1 wherein a recipient uses application specific software (APP) to modify a mobile communication device, such as a smartphone, in order to access an online booking system.

17. The tracking system according to claim 16 wherein the online booking system provides a user with a menu of choices, including an option for selecting an alternative delivery time and date, an option for returning the item and an option for collecting the item from a specified location.

18. (canceled)

19. The tracking system according to claim 17 wherein the application specific software (APP) is operative to configure the mobile communication device, (smartphone) to display or transmit a release signal to an automatic release means on the secure locker.

20-26. (canceled)

27. The hand-held scanner for use with the system according to claim 1 the hand-held scanner comprises: an imaging means, a memory means, a global positioning system (GPS) device, a processor, a battery and a wireless communication device, the imaging means is operative to scan a unique identifier on a reusable token and the processor is operative to generate a unique identification code, to be associated with an undelivered item, at an address corresponding to received GPS location data, at the time and date corresponding to when the reusable token is scanned; the memory means stores the unique identification code; and the wireless communication device is operative to transmit the unique identification code to a remote server.

28. The hand-held scanner according to claim 27 wherein the scanner operates in accordance with software to derive address information from a barcode on an address label (or on a payment label); or from a QR code on an address label (or on a payment label).

29-32. (canceled)

33. The hand-held scanner according to claim 27 wherein the hand-held scanner includes an optical character recognition (OCR) device.

34-37. (canceled)

38. The reusable token for use with the system according to claim 1 has a unique identifier, such as a QR code and/or a barcode, which when scanned by a smartphone generates a notification on a display of the smartphone and connects the smartphone to a remote database.
